(19) United States
(12) Patent Application Publication
(10) Pub. No.: US 2026/0246154 A1
(43) Pub. Date: Aug. 20, 2026

(54) ACTIVE DUAL-BAND LIQUID CRYSTAL TRANSMISSIVE AND REFLECTIVE ARRAY STRUCTURE

(71) Applicants: NATIONAL TAIWAN UNIVERSITY OF SCIENCE AND TECHNOLOGY, Taipei City (TW); TMY TECHNOLOGY INC., New Taipei City (TW)

(72) Inventors: Hsi-Hsir CHOU, Taipei City (TW); Zi-Ji WANG, New Taipei City (TW)

(21) Appl. No.: 19/193,535

(22) Filed: Apr. 29, 2025

(30) Foreign Application Priority Data
Feb. 14, 2025 (TW) 114105566

(51) Int. Cl. H01Q 15/00; G02F 1/139; H01Q 21/06

(52) U.S. Cl. CPC H01Q 15/0086; G02F 1/1391; H01Q 21/065

(57) ABSTRACT

The present invention provides an active dual-band liquid crystal transmissive and reflective array structure. The structure comprises a first substrate layer, a first liquid crystal layer, and a second substrate layer. Each of the first substrate layer and the second substrate layer has four surface units, and components on the different surface units are used to form a reflective cell unit and a transmissive cell unit. When the first liquid crystal layer is not biased, the reflective unit cell can be used as a reflective surface at an operating frequency of 27~29 GHz; when the first liquid crystal layer is biased, the transmissive unit cell can be used as a transmissive surface at an operating frequency of 17~19 GHz.

### TECHNICAL FIELD

The present invention relates to an active dual-band liquid crystal transmissive and reflective array structure, in particular to an adjustable liquid crystal transmissive and reflective array design suitable for a 5G millimeter wave communication frequency band and a low-earth-orbit satellite communication frequency band.

### BACKGROUND OF THE INVENTION

The array structures commonly found in the current literature can be roughly divided into two categories: a passive array structure and an array structure in which each unit can be controlled individually.

The passive array structure can be further divided into a single-band array structure and a dual-band array structure. The advantages of the passive array structure are excellent performance and stability, but the disadvantage thereof is the lack of adjustability. Since the space is always filled with various electromagnetic waves of different frequency bands, the disadvantage of the passive array structure that it cannot be adjusted is infinitely magnified. The passive array structure can no longer adapt to the needs of operating frequency bands and different beamforming directions.

The array structure in which each unit can be controlled individually is limited in array size due to the circuit design. Although it has good phase operation capability, it is still not comparable to the passive array structure in terms of performance, and it is also unable to achieve the function of beamforming after electromagnetic wave penetration.

It can be seen from the above that passive array structure and the array structure in which each unit can be controlled individually still have their limitations. Therefore, the present invention is based on improved designs of the dual-band transmissive array structure, the dual-band reflective array structure, and the dual-band transmissive and reflective array structure. The traditional single-band array structure can only achieve single-band beamforming. The dual-band array structure using dual-band design can achieve dual-band beamforming, but it also lacks flexibility in practicality.

Therefore, the present invention utilizes the electromagnetic characteristics of the dual-band transmissive and reflective array structure and introduces a liquid crystal material to achieve an adjustable effect. This innovation enables the array structure to switch mode according to external conditions and needs, thereby improving the flexibility and adaptability of the system while ensuring efficiency. As a result, the present invention should be an optimal solution.

### SUMMARY OF THE INVENTION

An active dual-band liquid crystal transmissive and reflective array structure comprises: a first substrate layer, having a first upper surface and a first lower surface; a second substrate layer, having a second upper surface and a second lower surface; a first liquid crystal layer, stacked and connected between the first substrate layer and the second substrate layer; a plurality of first surface units, arranged in an array on the first upper surface, wherein each first surface unit has four first surface outer frame patches and a first surface cross-shaped patch, wherein a first surface inner frame patch is disposed inside the first surface outer frame patch; a plurality of second surface units, arranged in an array on the first lower surface, wherein each second surface unit has four second surface rectangular patches, wherein the edges of each second surface rectangular patch are connected to four second surface metal wires, and a second surface cross-shaped slot is disposed at the center of the second surface rectangular patch; a plurality of third surface units, arranged in an array on the second upper surface, wherein each third surface unit has four third surface rectangular patches, wherein the edges of each third surface rectangular patch is connected to four third surface metal wires, and a third surface square slot is disposed at the center of the third surface rectangular patch; and a plurality of fourth surface units, arranged in an array on the second lower surface, wherein each fourth surface unit is a fourth surface cross-shaped patch, wherein the first surface outer frame patch, the first surface inner frame patch, the first substrate layer, the second surface rectangular patch, the four second surface metal wires connected to the edges of the second surface rectangular patch, the first liquid crystal layer, the second substrate layer, the third surface rectangular patch, the four third surface metal wires connected to the edges of the third surface rectangular patch form a reflective cell unit; when the first liquid crystal layer is not biased, the central operating frequency of the reflective cell unit is 27-29 GHz, wherein the first surface cross-shaped patch, the first substrate layer, the second surface unit, the first liquid crystal layer, the third surface unit, the second substrate layer, and the fourth surface unit form a transmissive cell unit; when the first liquid crystal layer is biased, the central operating frequency of the transmissive cell unit is 17~19 GHz.

More specifically, every the four first surface outer frame patches are arranged around the first surface cross-shaped patch; a first surface rectangular slit is disposed between the first surface outer frame patch and the first surface inner frame patch, and a first surface rectangular slot is disposed at the center of the first surface inner frame patch.

More specifically, every the four second surface rectangular patches and the second surface metal wire surrounds a second surface cross-shaped opening.

More specifically, every the four third surface rectangular patches and the third surface metal wire surrounds a third surface cross-shaped opening.

More specifically, the first surface unit, the second surface unit, the third surface unit, and the fourth surface unit are formed of a metal material.

More specifically, before and after the first liquid crystal layer is biased, the dielectric constant of the first liquid crystal layer is 2.55~3.76, and the loss tangent thereof is 0.004~0.006.

More specifically, the length and width of the first surface outer frame patch are 0.5~3.3 mm.

More specifically, the first surface cross-shaped patch has a first longitudinal portion and a first transverse portion, and the lengths of the first longitudinal portion and the first transverse portion are 1.5~8.5 mm.

More specifically, the second surface cross-shaped slot has a second longitudinal portion and a second transverse portion, the widths of the second longitudinal portion and the second transverse portion are 0.57~0.67 mm, and the lengths of the second longitudinal portion and the second transverse portion are 3.25~3.35 mm.

More specifically, when the first liquid crystal layer is not biased, the reflective cell unit can be used as a reflective surface at the central operating frequency of 27~29 GHz; when the first liquid crystal layer is biased, the transmissive cell unit can be used as a transmissive surface at the central operating frequency of 17~19 GHz.

### BRIEF DESCRIPTION OF DRAWINGS

FIG. 1A is a multi-layer structure schematic diagram of an active dual-band liquid crystal transmissive and reflective array structure of the present invention.

FIG. 1B is a schematic cross-sectional view of the active dual-band liquid crystal transmissive and reflective array structure of the present invention.

FIG. 2A is a schematic diagram of a cell design of a first surface unit of the active dual-band liquid crystal transmissive and reflective array structure of the present invention.

FIG. 2B is a schematic diagram of a cell design of a second surface unit of the active dual-band liquid crystal transmissive and reflective array structure of the present invention.

FIG. 2C is a schematic diagram of a cell design of a third surface unit of the active dual-band liquid crystal transmissive and reflective array structure of the present invention.

FIG. 2D is a schematic diagram of a cell design of a fourth surface unit of the active dual-band liquid crystal transmissive and reflective array structure of the present invention.

FIG. 3A is a schematic diagram of a reflective cell unit of the active dual-band liquid crystal transmissive and reflective array structure of the present invention.

FIG. 3B is a schematic diagram showing the reflection coefficient and phase vs. size of the reflective cell unit of the active dual-band liquid crystal transmissive and reflective array structure of the present invention before its liquid crystal is biased.

FIG. 3C is a schematic diagram showing the performance of the reflective cell unit of the active dual-band liquid crystal transmissive and reflective array structure of the present invention before its liquid crystal is biased.

FIG. 4A is a schematic diagram of a transmissive cell unit of the active dual-band liquid crystal transmissive and reflective array structure of the present invention.

FIG. 4B is a schematic diagram showing the reflection coefficient and phase vs. size of the transmissive cell unit of the active dual-band liquid crystal transmissive and reflective array structure of the present invention after its liquid crystal is biased.

FIG. 4C is a schematic diagram showing the performance of the transmissive cell unit of the active dual-band liquid crystal transmissive and reflective array structure of the present invention after its liquid crystal is biased.

FIG. 5A is a schematic diagram showing the phase distribution required for cell reflection of the active dual-band liquid crystal transmissive and reflective array structure of the present invention before its liquid crystal is biased.

FIG. 5B is a schematic diagram showing the phase distribution required for cell transmission of the active dual-band liquid crystal transmissive and reflective array structure of the present invention after its liquid crystal is biased.

FIG. 6A is a schematic diagram showing a reflective array architecture of a first embodiment of the active dual-band liquid crystal transmissive and reflective array structure of the present invention before its liquid crystal is biased.

FIG. 6B is a polar diagram of a reflective array of the first embodiment of the active dual-band liquid crystal transmissive and reflective array structure of the present invention before its liquid crystal is biased.

FIG. 6C is a gain diagram of the reflective array of the first embodiment of the active dual-band liquid crystal transmissive and reflective array structure of the present invention before its liquid crystal is biased.

FIG. 7A is a schematic diagram showing a reflective array architecture of a second embodiment of the active dual-band liquid crystal transmissive and reflective array structure of the present invention before its liquid crystal is biased.

FIG. 7B is a polar diagram of a reflective array of the second embodiment of the active dual-band liquid crystal transmissive and reflective array structure of the present invention before its liquid crystal is biased.

FIG. 7C is a gain diagram of the reflective array of the second embodiment of the active dual-band liquid crystal transmissive and reflective array structure of the present invention before its liquid crystal is biased.

FIG. 8A is a schematic diagram showing a transmissive array architecture of a third embodiment of the active dual-band liquid crystal transmissive and reflective array structure of the present invention after its liquid crystal is biased.

FIG. 8B is a polar diagram of a transmissive array of the third embodiment of the active dual-band liquid crystal transmissive and reflective array structure of the present invention after its liquid crystal is biased.

FIG. 8C is a gain diagram of the reflective array of the third embodiment of the active dual-band liquid crystal transmissive and reflective array structure of the present invention after its liquid crystal is biased.

FIG. 9A is a schematic diagram showing a transmissive array architecture of a fourth embodiment of the active dual-band liquid crystal transmissive and reflective array structure of the present invention after its liquid crystal is biased.

FIG. 9B is a polar diagram of a transmissive array of the fourth embodiment of the active dual-band liquid crystal transmissive and reflective array structure of the present invention after its liquid crystal is biased.

FIG. 9C is a gain diagram of the reflective array of the fourth embodiment of the active dual-band liquid crystal transmissive and reflective array structure of the present invention after its liquid crystal is biased.

FIG. 10A is a schematic diagram showing a transmissive array architecture of a fifth embodiment of the active dual-band liquid crystal transmissive and reflective array structure of the present invention after its liquid crystal is biased.

FIG. 10B is a polar diagram of a transmissive array of the fifth embodiment of the active dual-band liquid crystal transmissive and reflective array structure of the present invention after its liquid crystal is biased.

FIG. 10C is a gain diagram of the reflective array of the fifth embodiment of the active dual-band liquid crystal transmissive and reflective array structure of the present invention after its liquid crystal is biased.

### DETAILED DESCRIPTION OF THE INVENTION

Other technical contents, features, and effects of the present invention will become apparent from the following detailed description of the preferred embodiments with reference to the drawings.

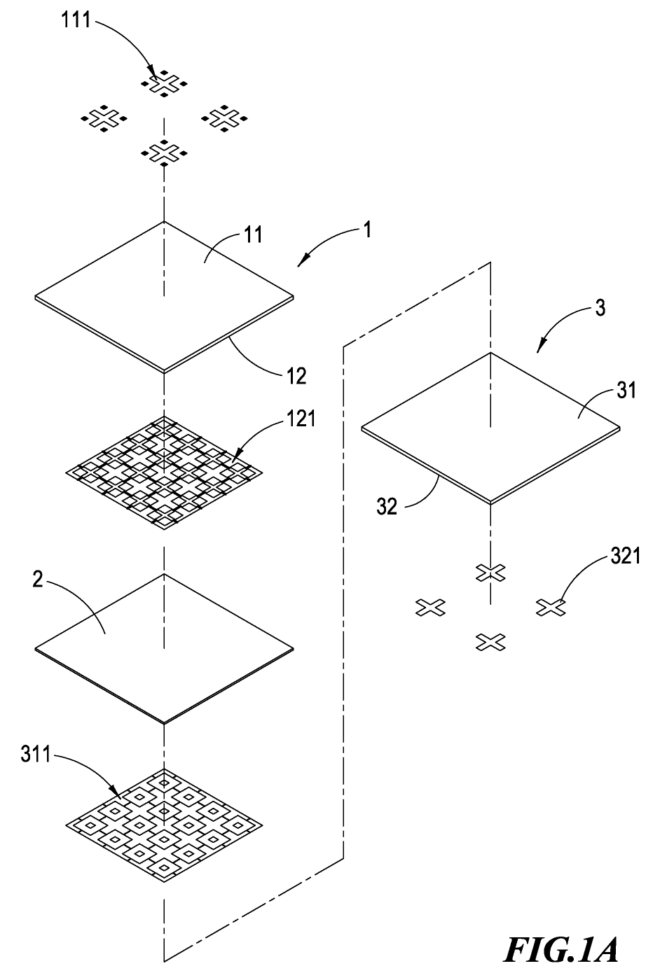

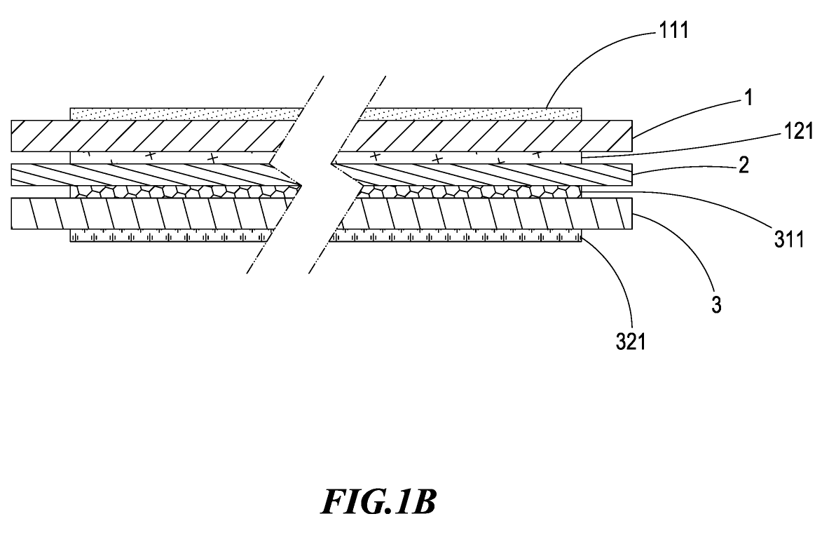

Please refer to FIGS. 1A and 1B, which are a multi-layer structure schematic diagram and a schematic cross-sectional view of an active dual-band liquid crystal transmissive and reflective array structure of the present invention respectively. As shown in the figures, the active dual-band liquid crystal transmissive and reflective array structure is mainly designed as a two-layer four-sided circuit board. The active dual-band liquid crystal transmissive and reflective array structure includes a first substrate layer 1, a first liquid crystal layer 2, and a second substrate layer 3, wherein the first liquid crystal layer 2 is stacked and connected between the first substrate layer 1 and the second substrate layer 3.

The first substrate layer 1 and the second substrate layer 3 are high-frequency printed circuit boards with dielectric constant of 3.25~3.41, loss tangent of 0.0020.0025, and copper foil thickness of 0.017~0.018 mm but the present invention is not limited to this type of circuit board.

AS to the first liquid crystal layer 2, the liquid crystal material used in the present embodiments is JNC ZOC-A018XX with a thickness of 0.1 mm. The liquid crystal layer has dielectric constant of 2.55~3.76 and loss tangent of 0.004~0.006 before and after being biased.

In order to enable the first liquid crystal layer 2 to be biased, since the first liquid crystal layer 2 is sandwiched between the first substrate layer 1 and the second substrate layer 3, in actual implementation in the industry, the first substrate layer 1 and the second substrate layer 3 are both designed with a metal edge on all four edges. Therefore, as long as a bias voltage is applied to the metal edges of the first substrate layer 1 and the second substrate layer 3 above and below the first liquid crystal layer 2 respectively, a pressure difference between the upper and lower surfaces of the entire liquid crystal layer can be created. This feature is well known in the industry so it will not be specially marked in the figures.

The best embodiment of the first liquid crystal layer 2 is that before a bias voltage is applied (OV), the liquid crystal alignment direction is parallel to the electric field, and its dielectric constant is 2.55, and its loss tangent is 0.006. After a bias voltage is applied (5V~20V), the liquid crystal alignment direction is perpendicular to the electric field, and its dielectric constant becomes 3.76, and its loss tangent is 0.004). However, the present invention is not limited to this type of liquid crystal material.

The first substrate layer 1 has a first upper surface 11 and a first lower surface 12.

The second substrate layer 3 has a second upper surface 31 and a second lower surface 32.

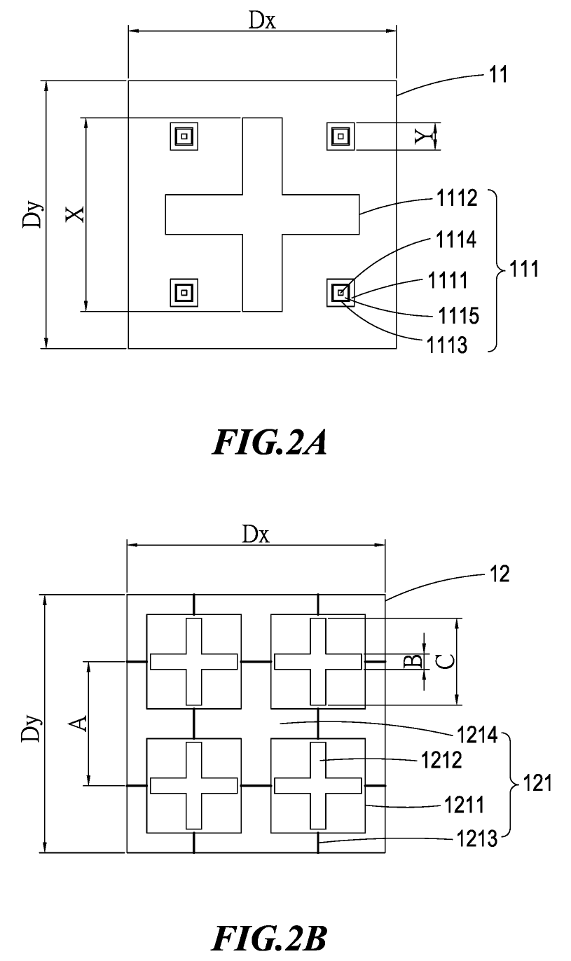

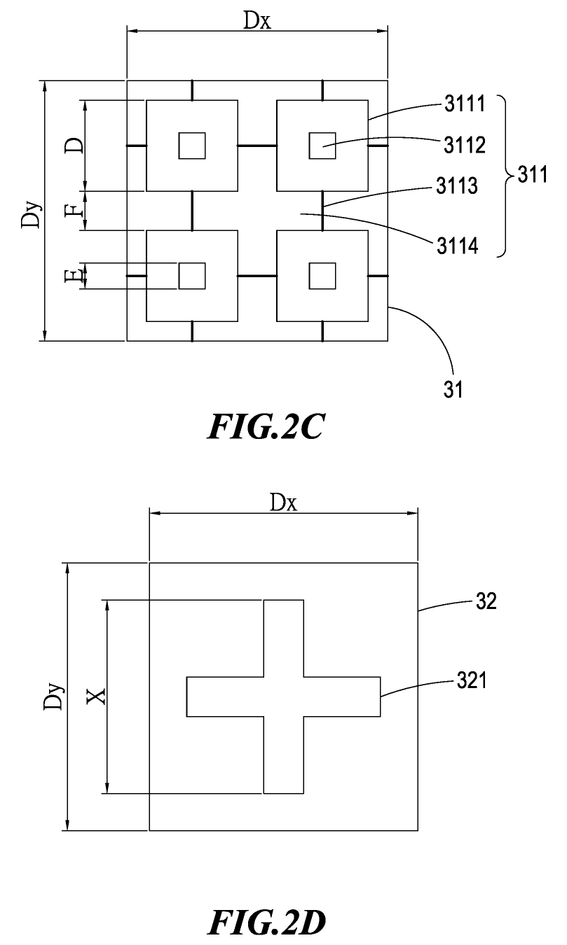

As shown in FIG. 2A , a plurality of first surface units 111 arranged in an array are formed on the first upper surface 11. As shown in the figure, the first surface unit 111 has four first surface outer frame patches 1111 and a first surface cross-shaped patch 1112.

Every four first surface outer frame patches 1111 are arranged around the first surface cross-shaped patch 1112. A first surface rectangular slit 1113 is provided between the first surface outer frame patch 1111 and a first surface inner frame patch 1115, and a first surface rectangular slot 1114 is provided in the center of the first surface inner frame patch 1115.

The first surface rectangular slit 1113 is larger than the first surface rectangular slot 1114.

Further, in terms of the preparation process, the first upper surface 11 has a plurality of regular rectangular units (Dx is 8 mm, Dy is 8 mm), and an original metal layer (such as copper foil) of the first upper surface 11 is removed by etching to form a plurality of first surface units 111 on the first upper surface 11.

Further, in terms of the preparation dimensions, as shown in FIG. 2A, the first surface unit 111 is designed with the first surface outer frame patches 1111, the first surface cross- shaped patch 1112, the first surface rectangular slits 1113, the first surface rectangular slots 1114, and the first surface inner frame patches 1115.

The length and width of the first surface outer frame patch 1111 are 0.5~3.3 mm (Y).

The length and width of the first surface rectangular slit 1113 are 0.05~0.33 mm.

The length and width of the first surface rectangular slot 1114 are 0.25~1.65 mm.

The length and width of the first surface inner frame patch 1115 are 0.35-2.31 mm.

The first surface cross-shaped patch 1112 has a first longitudinal portion and a first transverse portion. The lengths of the first longitudinal portion and the first transverse portion are 1.5~8.5 mm (X is 1.5~8.5 mm).

As shown in FIG. 2B, a plurality of second surface units 121 arranged in an array are formed on the first lower surface 12. As shown in the figure, each second surface unit 121 has four second surface rectangular patches 1211, wherein the edges of each second surface rectangular patch 1211 are connected with four second surface metal wires 1213, and a second surface cross-shaped slot 1212 is provided in the center of the second surface rectangular patch 1211.

The position of the second surface cross-shaped slot 1212 corresponds to the position of the first surface rectangular slot 1114.

Every four second surface rectangular patches 1211 and the second surface metal wire 1213 surround a second surface cross-shaped opening 1214.

The position of the second surface cross-shaped opening 1214 corresponds to the position of the first surface cross-shaped patch 1112.

Further, in terms of the preparation process, as shown in FIG. 2B , the first lower surface 12 has a plurality of regular rectangular units (Dx is 8 mm, Dy is 8 mm), and an original metal layer (such as copper foil) of the first lower surface 12 is removed by etching to form a plurality of second surface units 121 on the first lower surface 12.

Further, in terms of the preparation dimensions, the second surface unit 121 is designed with the second surface rectangular patches 1211, the second surface cross- shaped slots 1212, and the second surface metal wires 1213.

The length and width of the second surface rectangular patch 1211 are 3.9~4.1 mm.

The second surface cross-shaped slot 1212 has a second longitudinal portion and a second transverse portion. The widths of the second longitudinal portion and the second transverse portion are 0.57-0.67 mm (B), and the lengths of the second longitudinal portion and the second transverse portion are 3.25-3.35 mm (C).

The length of the second surface metal wire 1213 is 0.3~0.35 mm.

The second surface cross-shaped opening 1214 has a second longitudinal portion and a second transverse portion. The lengths of the second longitudinal portion and the second transverse portion are 4.55-4.62 mm.

As shown in FIG. 2C , a plurality of third surface units 311 arranged in an array are formed on the second upper surface 31. As shown in the figure, each third surface unit 311 has four third surface rectangular patches 3111, wherein the edges of each third surface rectangular patch 3111 are connected with four third surface metal wires 3113, and a third surface square slot 3112 is provided in the center of the third surface rectangular patch 3111.

The position of the third surface rectangular patch 3111 corresponds to the position of the second surface rectangular patch 1211.

The position of the third surface square slot 3112 corresponds to the position of the second surface cross-shaped slot 1212.

Every four third surface rectangular patches 3111 and the third surface metal wire 3113 surround a third surface cross-shaped opening 3114.

The position of the third surface cross-shaped opening 3114 corresponds to the position of the second surface cross-shaped opening 1214.

Further, in terms of the preparation process, as shown in FIG. 2C , the second upper surface 31 has a plurality of regular rectangular units (Dx is 8 mm, Dy is 8 mm), and an original metal layer (such as copper foil) of the second upper surface 31 is removed by etching to form a plurality of third surface units 311 on the second upper surface 31.

Further, in terms of the preparation dimensions, the third surface unit 311 has the third surface rectangular patches 3111, the third surface square slots 3112, the third surface metal wires 3113, the third surface cross-shaped opening 3114.

The length and width of the third surface rectangular patch 3111 are 2.95~3.05 mm (D).

The length and width of the third surface square slot 3112 are 0.85~0.95 mm (E).

The length of the third surface metal wire 3113 is 1.6~1.7 mm (F).

The third surface cross-shaped opening 3114 has a third longitudinal portion and a third transverse portion. The length and width of the third longitudinal portion and the third transverse portion are 1.6~1.7 mm.

As shown in FIG. 2D , a plurality of fourth surface units arranged in an array are formed on the second lower surface 32. As shown in the figure, the fourth surface unit is a fourth surface cross-shaped patch 321.

The position of the fourth surface cross-shaped patch 321 corresponds to the position of the third surface cross-shaped opening 3114.

Further, in terms of the preparation process, as shown in FIG. 2D , the second lower surface 32 has a plurality of regular rectangular units (Dx is 8 mm, Dy is 8 mm), and an original metal layer (such as copper foil) of the second lower surface 32 is removed by etching to form a plurality of fourth surface units on the second lower surface 32.

Further, in terms of the preparation dimensions, the fourth surface unit is the fourth surface cross-shaped patch 321. The fourth surface cross-shaped patch 321 has a fourth longitudinal portion and a fourth transverse portion. The lengths of the fourth longitudinal portion and the fourth transverse portion are 1.58.5 mm (X is 1.58.5 mm).

The first surface unit, the second surface unit, the third surface unit, and the fourth surface unit are formed of a metal material (such as copper foil) with a thickness of 0.035 mm.

The first substrate layer 1, the first liquid crystal layer 2, and the second substrate layer 3 are stacked to form the active dual-band liquid crystal transmissive and reflective array structure.

In the present invention, when the double patches (the double patches here refer to the first surface cross-shaped patch 1112 and the fourth surface cross-shaped patch 321) align with each other, the transmission response can produce a great broadband effect so that S21 and S11 of this design always remain stable. The main effects of the relevant parameters in this structure are that the aforementioned X and Y, which are the dimensions of the variable patches, can determine the angle of the transmissive or reflective phase while B can determine the size of its bandwidth, and C can determine the center frequency of the device.

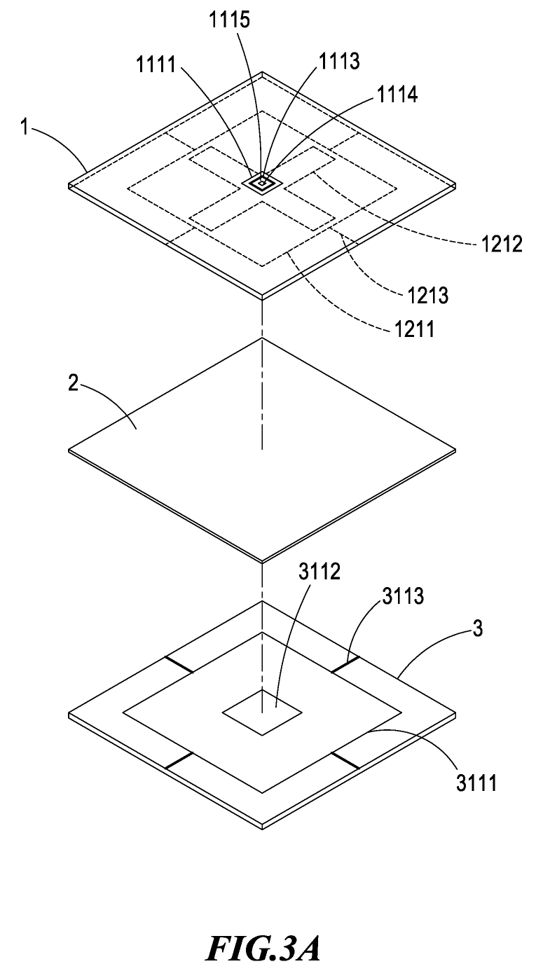

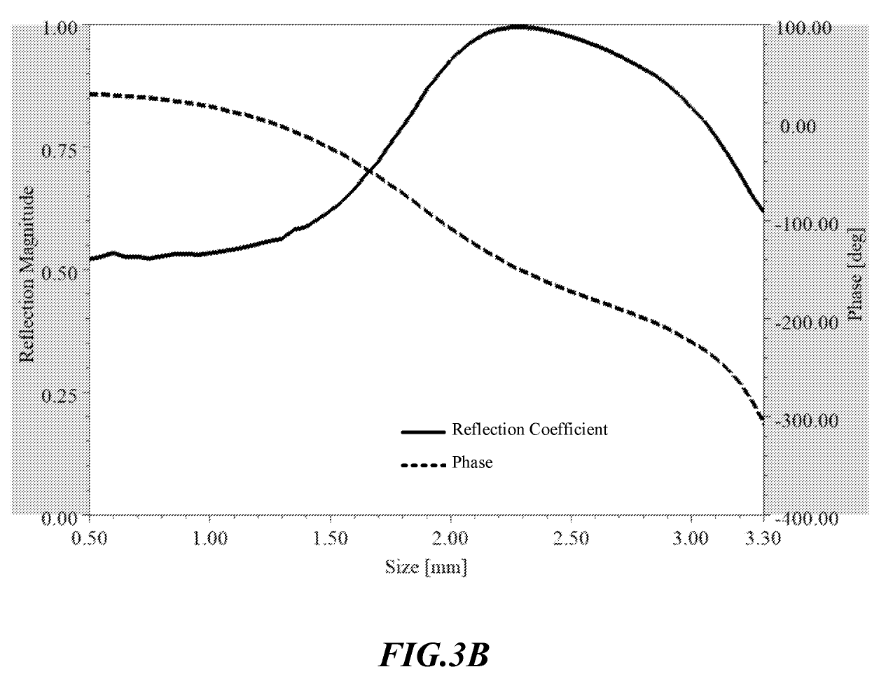

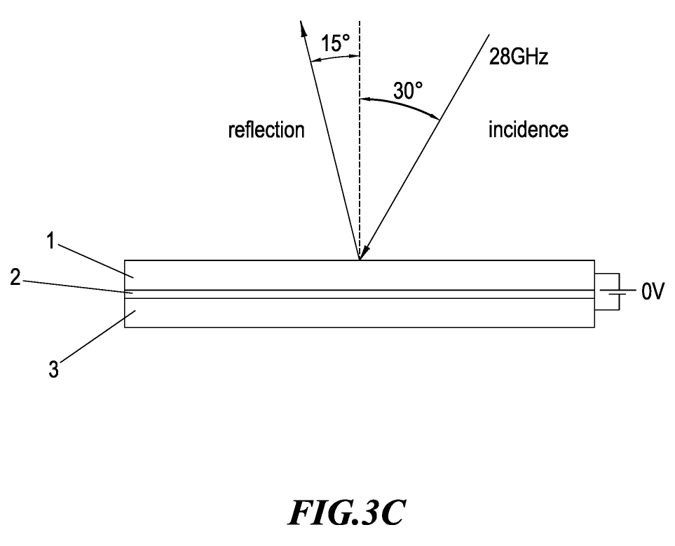

A reflective cell unit of the present invention is composed of partial areas of the first substrate layer 1, the first liquid crystal layer 2, and the second substrate layer 3. The range of the reflective cell unit is 4.7 mm. As shown in FIG. 3A, the structure is designed with two layers of substrates. The two layers of substrates use high-frequency printed circuit boards. At this time, the liquid crystal is in an unbiased state (OV).

The first surface outer frame patch 1111, the first surface inner frame patch 1115, the first substrate layer 1, the second surface rectangular patch 1211 and the four second surface metal wires 1213 connected to the edges of the second surface rectangular patch 1211, the first liquid crystal layer 2, the second substrate layer 3, the third surface rectangular patch 3111 and the four third surface metal wires 3113 connected to the edges of the third surface rectangular patch 3111 form a reflective unit cell. When the first liquid crystal layer 2 is not biased, the central operating frequency of the reflective unit cell is between 27 GHz and 29 GHz, and the wavelength of the operating frequency in the present invention is related to the size of the cell unit.

As shown in FIG. 3B , it is a graph showing reflection coefficient value (magnitude) S11 vs. size and phase vs. size, wherein a solid curve shows reflection coefficient S11 value (magnitude) vs. size, its horizontal axis represents the patch size Y, and its vertical axis represents the reflection coefficient value; a dashed curve shows phase vs. size, its horizontal axis represents the patch size Y, and its vertical axis represents the phase. The average reflection coefficient of the reflective cell unit is about 0.75, and the phase change also reaches 335 degrees, meeting the performance standards of the reflective array design.

As shown in FIG. 3C , before being biased, the array structure of the present invention can reflect a 28 GHz plane electromagnetic wave incident at an angle of 30 degrees with respect to the normal, at an angle of 15 degrees with respect to the normal, and the incident angle, the reflection angle, or the transmission angle can be adjusted as needed.

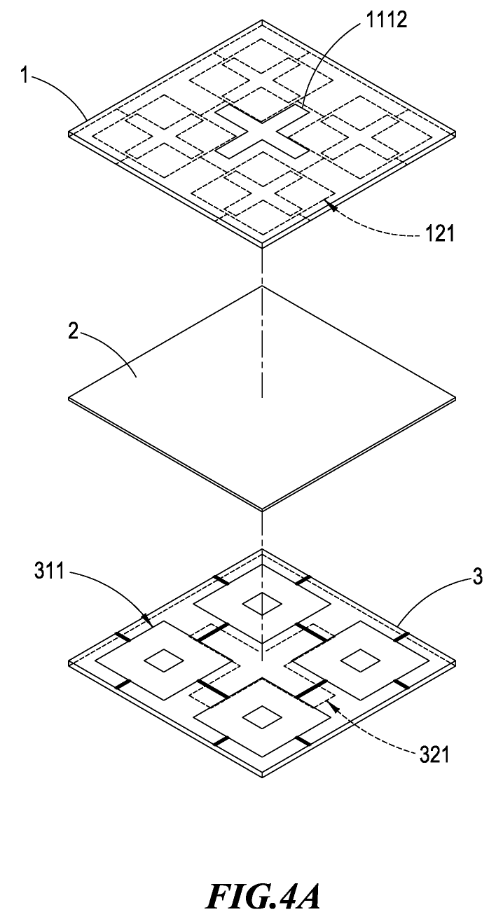

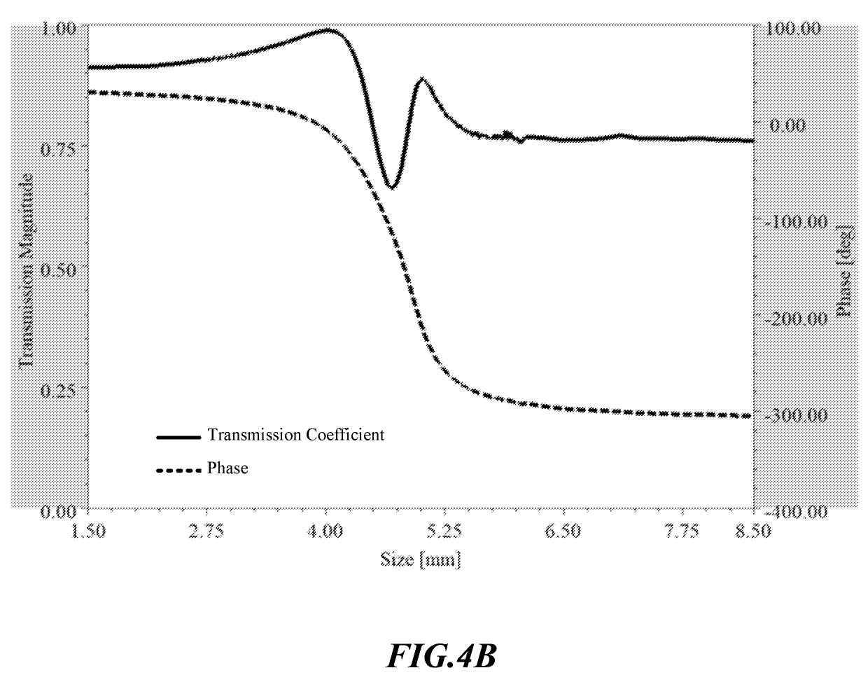

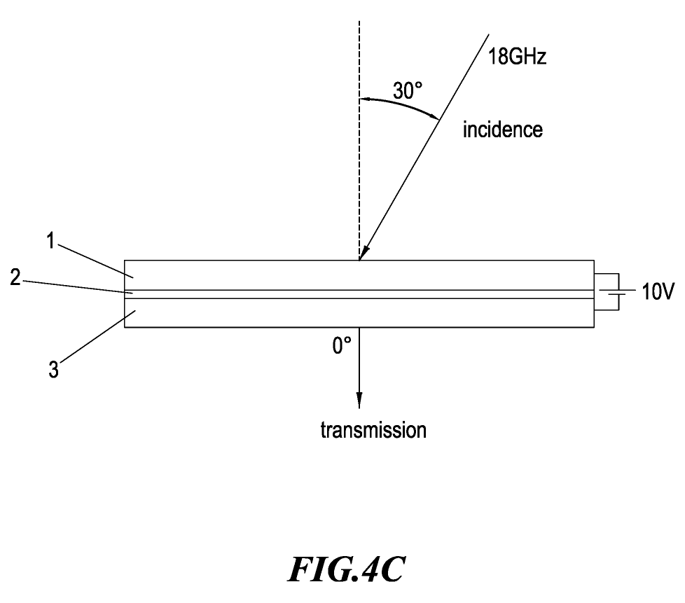

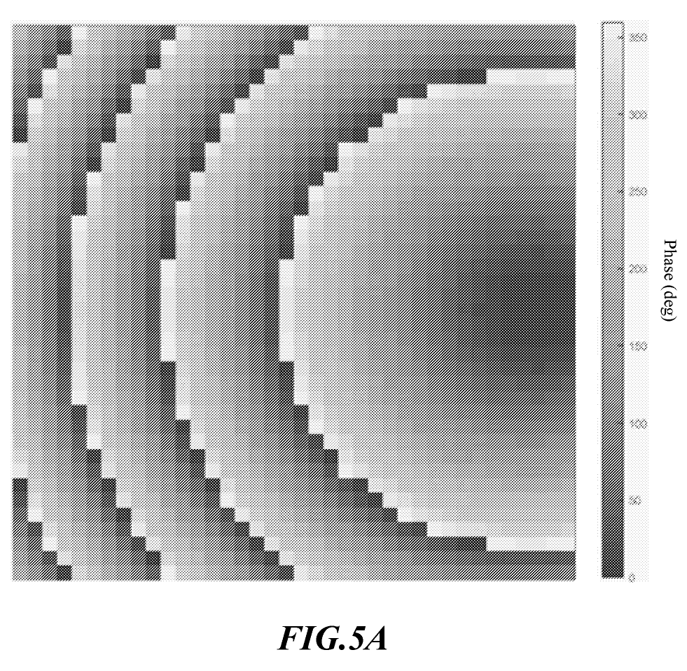

A transmissive cell unit of the present invention is composed of four cells. The range of the transmissive cell unit is 9.4 mm. As shown in FIG. 4A, the structure is designed with two layers of substrates. The two layers of substrates use high-frequency printed circuit boards.

The first surface cross-shaped patch 1112, the first substrate layer 1, the second surface unit 121, the first liquid crystal layer 2, the third surface unit 311, the second substrate layer 3, and the fourth surface unit (the fourth surface cross-shaped patch 321) form a transmissive cell unit. When the first liquid crystal layer is biased with an electromagnetic wave incident, the central operating frequency of the transmissive cell unit is between 17 GHz and 19 GHz.

As shown in FIG. 4B , it is a graph showing transmission coefficient value (magnitude) S21 vs. size and phase vs. size, wherein a solid curve shows transmission coefficient S21 value (magnitude) vs. size, its horizontal axis represents the patch size X, and its vertical axis represents the transmission coefficient value; a dashed curve shows phase vs. size, its horizontal axis represents the patch size X, and its vertical axis represents the phase. The average transmission coefficient of the transmissive cell unit is about 0.85, and the phase change also reaches 335 degrees, meeting the performance standards of the transmissive array design.

As shown in FIG. 4C, after being biased, the array structure of the present invention can transmit a 18 GHz plane electromagnetic wave incident at an angle of 30 degrees with respect to the normal, at an angle of 0 degree with respect to the normal.

In actual application, it is necessary to make an adjustment according to the current situation so as to meet the angle required for phase compensation of each unit.

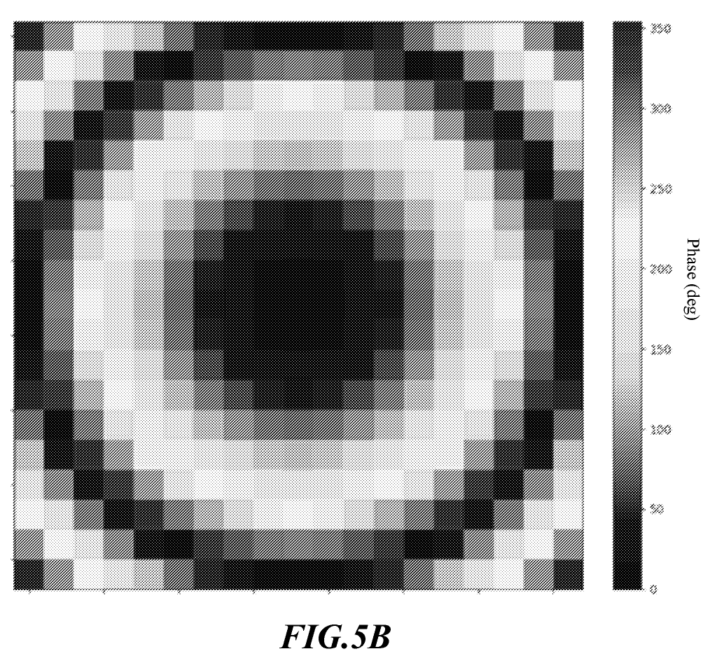

As shown in FIG. 5A, in a 28GHz frequency band, phase compensation calculated for the cell is based on the setting of 30 degrees of incidence and 15 degrees of reflection. As shown in the figure, the grayscale color gradient represents a simulated ideal phase distribution (phase compensation) from 0 degree to 360 degrees.

As shown in FIG. 5B, in an 18GHz frequency band, phase compensation calculated for the cells is based on the setting of 0 degree of incidence and 0 degree of transmission. As shown in the figure, the grayscale color gradient represents a simulated ideal phase distribution (phase compensation) from 0 degree to 360 degrees. Once obtaining an array unit phase table, we can arrange a required transmissive or reflective array by using the corresponding cell size.

The phase required for the above phase compensation can be calculated through a formula, and the calculation is certainly known to those with existing knowledge in this field so it will not be further described.

There are five implementations in the present invention. The first and second implementations are operated in Ka-band while the third, fourth and fifth implementations are operated in Ku-band.

In the first implementation of the present invention, multiple reflective cell units are arranged, wherein the reflection coefficient thereof is about 0.75 on average as the patch size Y changes, and the phase change is also greater than 335 degrees, meeting the performance standards of the reflective array design.

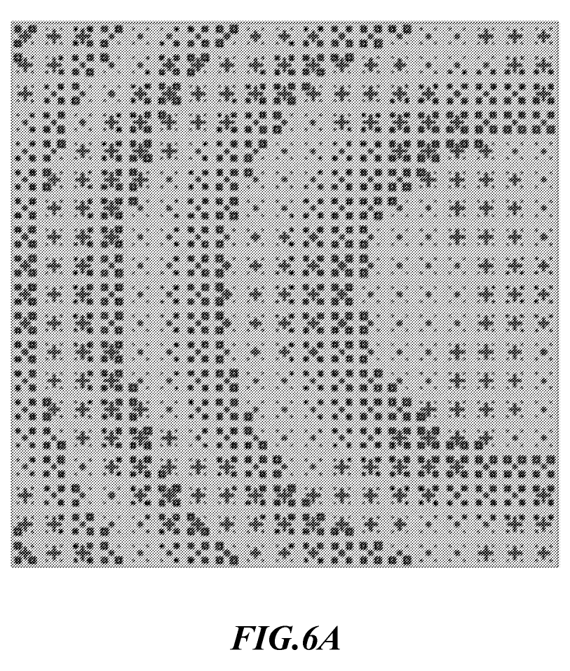

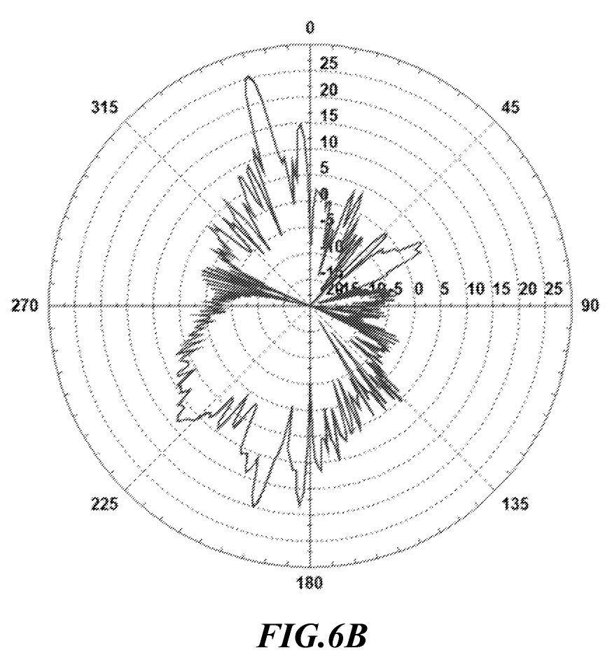

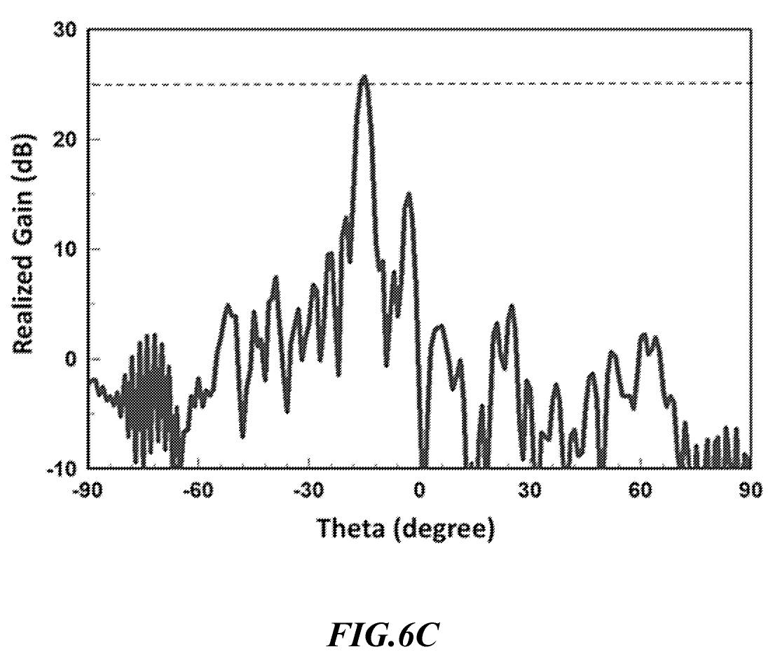

The reflective array surface is arranged according to this architecture, and the incident angle is selected as 30 degrees and the reflection angle is set to 15 degrees for design. The required phase result is calculated by a phase quantification formula and then, corresponds to the cell structure of this design. The final arranged array structure is shown in FIG. 6A.

As shown in FIG. 6A, since the wavelength of the 28 GHz electromagnetic wave is short as compared to that of the 18 GHz electromagnetic wave, the small cell (referring to the reflective cell unit mentioned in FIG. 3A) will serve as an incident object when the 28 GHz electromagnetic wave is incident.

In the present invention, the incident antenna is rotated 30 degrees clockwise from the Z axis for incidence. It can be observed that when the beam is incident at an angle of 30 degrees with respect to the normal from a certain distance (for example, 300mm), it can be reflected at an angle of 15 degrees with respect to the normal.

In FIG. 6B, a polar diagram of the realized gain of this structure at 30 degrees of incidence and 15 degrees of reflection is shown; in FIG. 6C, a realized gain diagram of this structure at 30 degrees of incidence and 15 degrees of reflection is shown. As can be seen from the figure, the realized gain of this structure is 25.7 dB at 30 degrees of incidence and 15 degrees of reflection, and the side-lobe-level is about 10.7 dB. It can be seen that the present invention has the characteristics of reflected phase beam scanning in the 28GHz 5G communication frequency band.

In the second implementation of the present invention, multiple reflective cell units are arranged, wherein the reflection coefficient thereof is about 0.75 on average as the patch size Y changes, and the phase change is also greater than 335 degrees, meeting the performance standards of the reflective array design.

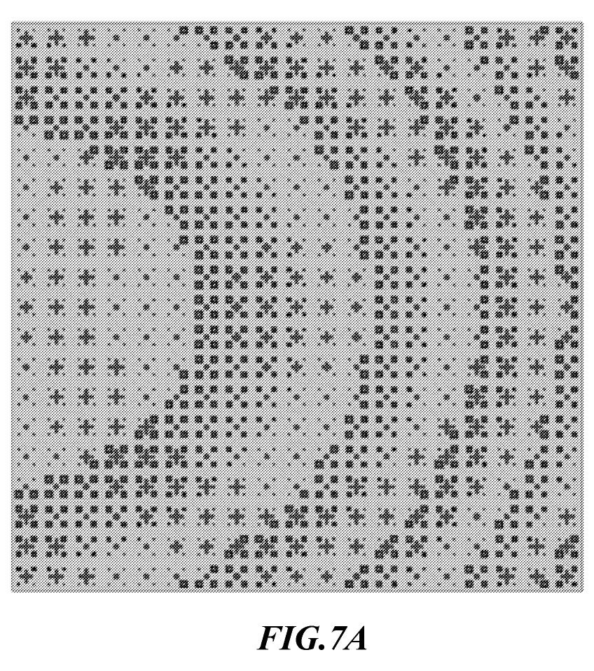

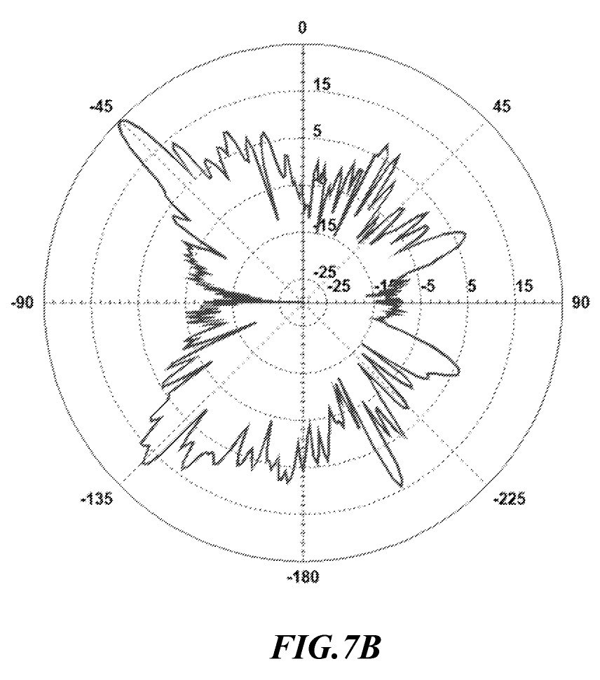

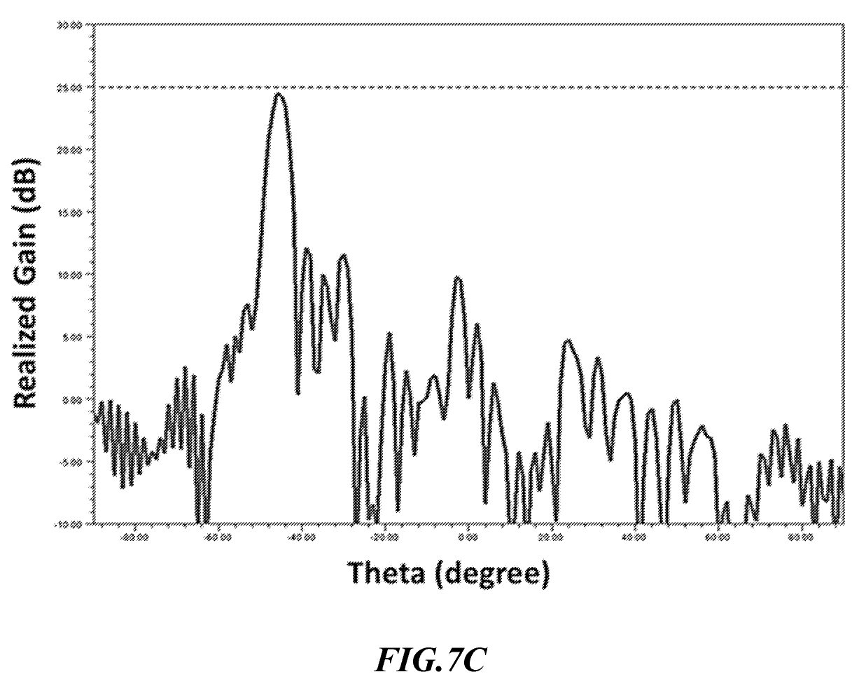

The reflective array surface is arranged according to this architecture, and the incident angle is selected as 30 degrees and the reflection angle is set to 45 degrees for design. The required phase result is calculated by the phase quantification formula and then, corresponds to the cell structure of this design. The final arranged array structure is shown in FIG. 7A.

As shown in FIG. 7A, since the wavelength of the 28 GHz electromagnetic wave is short as compared to that of the 18 GHz electromagnetic wave, the small cell (referring to the reflective cell unit mentioned in FIG. 3A) will serve as an incident object when the 28 GHz electromagnetic wave is incident.

In the present invention, the incident antenna is rotated 30 degrees clockwise from the Z axis for incidence. It can be observed that when the beam is incident at an angle of 30 degrees with respect to the normal from a certain distance (for example, 300mm), it can be reflected at an angle of 45 degrees with respect to the normal.

In FIG. 7B, a polar diagram of the realized gain of this structure at 30 degrees of incidence and 45 degrees of reflection is shown; in FIG. 7C, a realized gain diagram of this structure at 30 degrees of incidence and 45 degrees of reflection is shown. As can be seen from the figure, the realized gain of this structure is 24.5 dB at 30 degrees of incidence and 45 degrees of reflection, and the side-lobe-level is about 12.3 dB. It can be seen that the present invention has the characteristics of reflected phase beam scanning in the 28GHz 5G communication frequency band.

In the third implementation of the present invention, multiple transmissive cell units are arranged, wherein the transmission coefficient thereof is about 0.85 on average as the patch size Y changes, and the phase change is also greater than 335 degrees, meeting the performance standards of the transmissive array design.

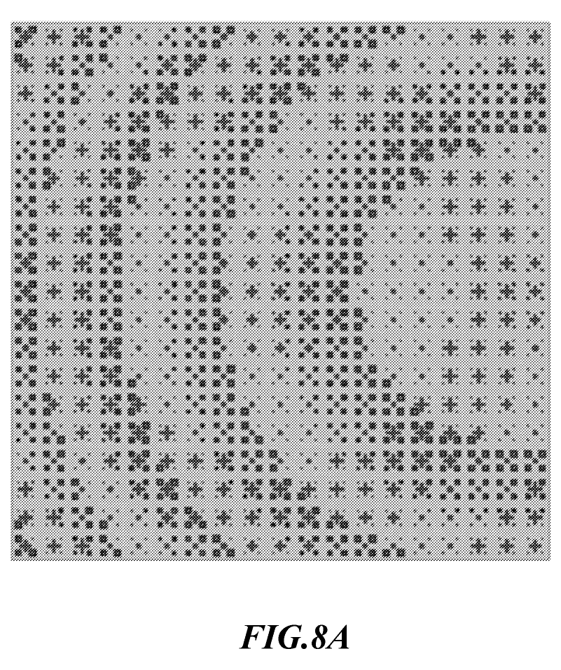

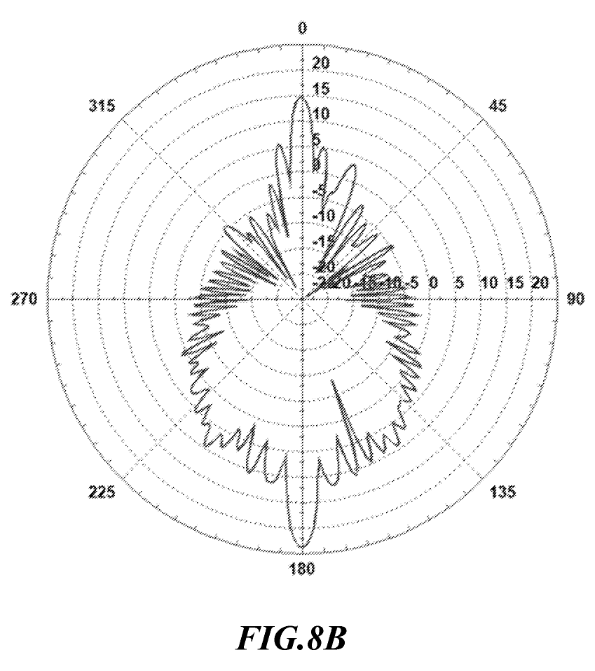

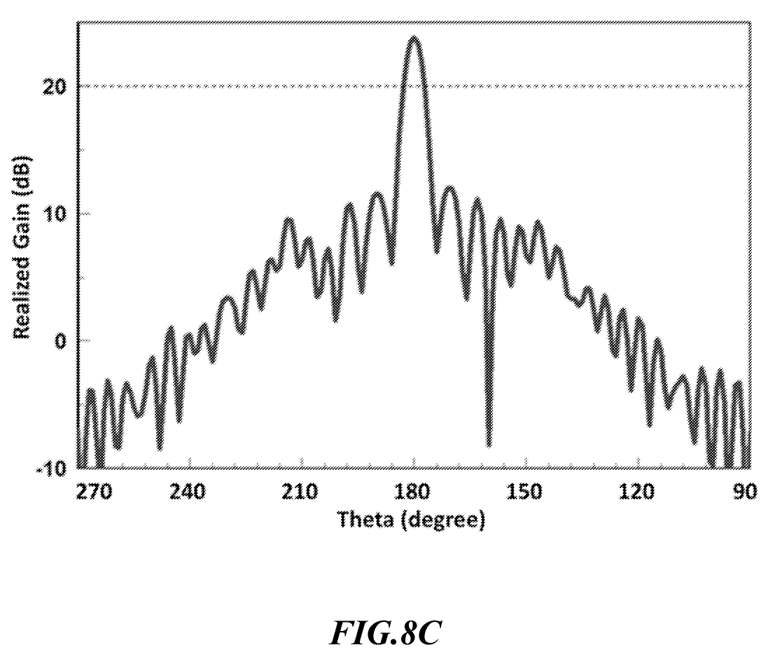

The transmissive array surface is arranged according to this architecture, and the incident angle is selected as 0 degree and the transmission angle is set to 0 degree for design. The required phase result is calculated by the phase quantification formula and then, corresponds to the cell structure of this design. The final arranged array structure is shown in FIG. 8A.

As shown in FIG. 8A, since the wavelength of the 18 GHz electromagnetic wave is long as compared to that of the 28 GHz electromagnetic wave, the large cell (referring to the transmissive cell unit mentioned in FIG. 4A) will serve as an incident object when the 18 GHz electromagnetic wave is incident.

In the the present invention, the incident antenna is positioned at an angle of 0 degree above the Z axis for incidence. It can be observed that when the beam is incident at an angle of 0 degree with respect to the normal from a certain distance (for example, 200mm), it can be transmitted at an angle of 0 degree with respect to the normal effectively.

In FIG. 8B, a polar diagram of the realized gain of this structure at 0 degree of incidence and 0 degree of transmission is shown; in FIG. 8C, a realized gain diagram of this structure at 0 degree of incidence and 0 degrees of transmission is shown. As can be seen from the figure, the realized gain of this structure is 23.8 dB at 0 degree of incidence and 0 degree of transmission, and the side-lobe-level is about 11.8 dB. It can be seen that the present invention has the characteristics of transmitted phase beam scanning in the 18GHz low-earth-orbit satellite communication frequency band.

In the fourth implementation of the present invention, multiple transmissive cell units are arranged, wherein the transmission coefficient thereof is about 0.85 on average as the patch size X changes, and the phase change is also greater than 335 degrees, meeting the performance standards of the transmissive array design.

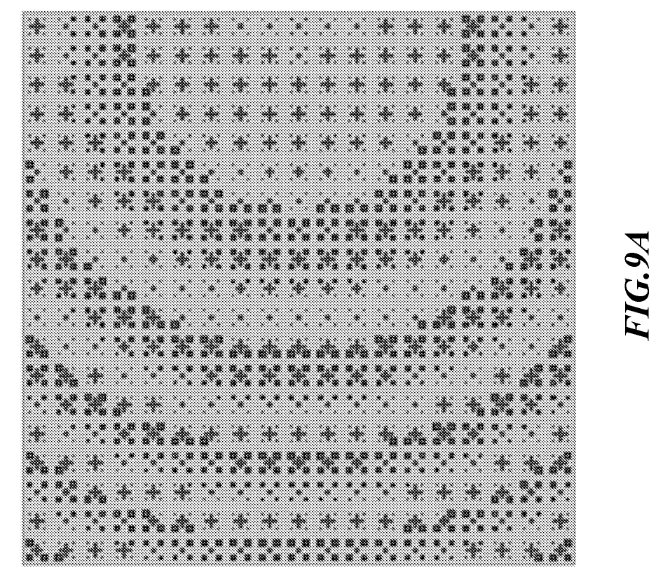

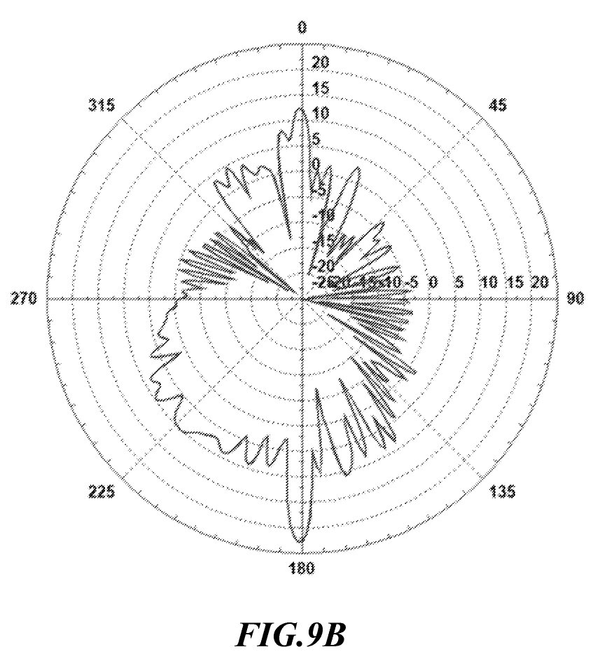

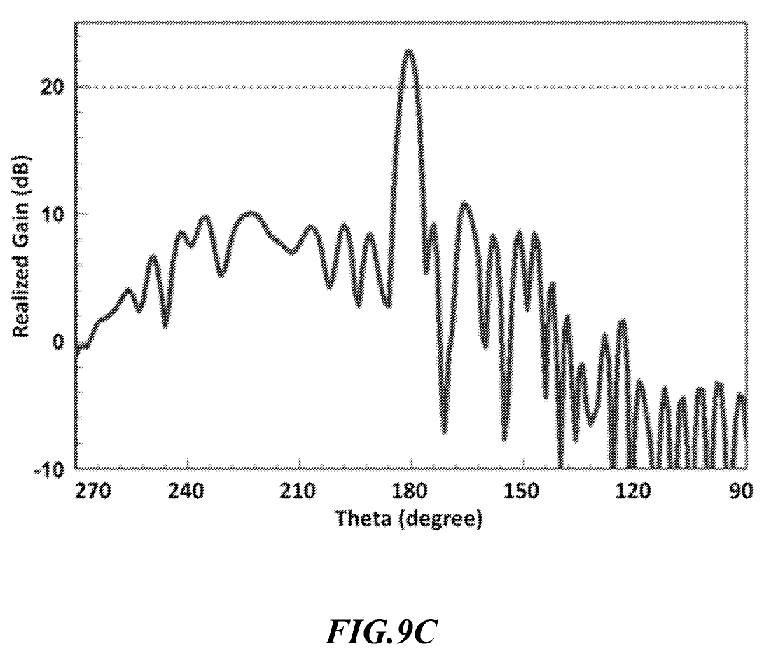

The transmissive array surface is arranged according to this architecture, and the incident angle is selected as 30 degrees and the transmission angle is set to 0 degree for design. The required phase result is calculated by the phase quantification formula and then, corresponds to the cell structure of this design. The final arranged array structure is shown in FIG. 9A.

As shown in FIG. 9A, since the wavelength of the 18 GHz electromagnetic wave is long as compared to that of the 28 GHz electromagnetic wave, the large cell (referring to the transmissive cell unit mentioned in FIG. 4A) will serve as an incident object when the 18 GHz electromagnetic wave is incident.

In the present invention, the incident antenna is rotated 30 degrees clockwise from the Z axis for incidence. It can be observed that when the beam is incident at an angle of 30 degrees with respect to the normal from a certain distance (for example, 200mm), it can be transmitted at an angle of 0 degree with respect to the normal effectively.

In FIG. 9B, a polar diagram of the realized gain of this structure at 30 degrees of incidence and 0 degree of transmission is shown; in FIG. 9C, a realized gain diagram of this structure at 30 degrees of incidence and 0 degrees of transmission is shown. As can be seen from the figure, the realized gain of this structure is 22.7 dB at 30 degree of incidence and 0 degree of transmission, and the side-lobe-level is about 11.9 dB. It can be seen that the present invention has the characteristics of transmitted phase beam scanning in the 18GHz low-earth-orbit satellite communication frequency band.

In the fifth implementation of the present invention, multiple transmissive cell units are arranged, wherein the transmission coefficient thereof is about 0.85 on average as the patch size X changes, and the phase change is also greater than 335 degrees, meeting the performance standards of the transmissive array design.

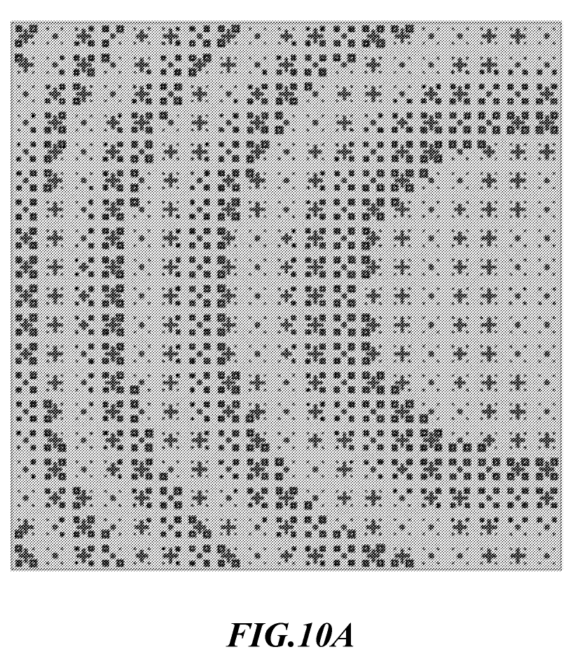

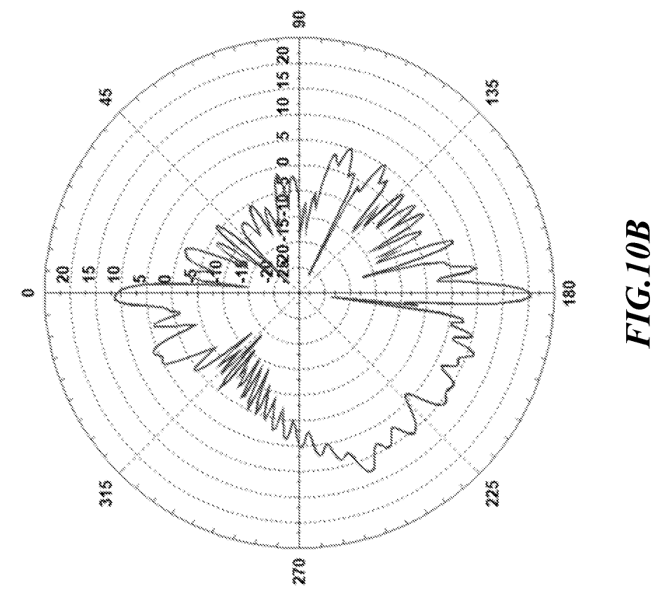

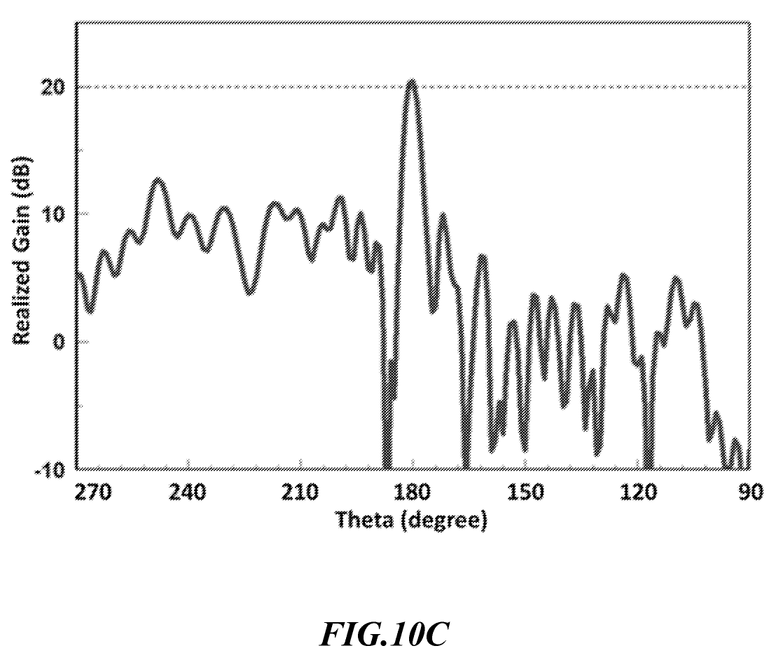

The transmissive array surface is arranged according to this architecture, and the incident angle is selected as 45 degrees and the transmission angle is set to 0 degree for design. The required phase result is calculated by the phase quantification formula and then, corresponds to the cell structure of this design. The final arranged array structure is shown in FIG. 10A.

As shown in FIG. 10A, since the wavelength of the 18 GHz electromagnetic wave is long as compared to that of the 28 GHz electromagnetic wave, the large cell (referring to the transmissive cell unit mentioned in FIG. 4A) will serve as an incident object when the 18 GHz electromagnetic wave is incident.

In the present invention, the incident antenna is rotated 45 degrees clockwise from the Z axis for incidence. It can be observed that when the beam is incident at an angle of 45 degrees with respect to the normal from a certain distance (for example, 200mm), it can be transmitted at an angle of 0 degree with respect to the normal effectively.

In FIG. 10B, a polar diagram of the realized gain of this structure at 45 degrees of incidence and 0 degree of transmission is shown; in FIG. 10C, a realized gain diagram of this structure at 45 degrees of incidence and 0 degrees of transmission is shown. As can be seen from the figure, the realized gain of this structure is 20.4 dB at 45 degree of incidence and 0 degree of transmission, and the side-lobe-level is about 10.4 dB. It can be seen that the present invention has the characteristics of transmitted phase beam scanning in the 18GHz low-earth-orbit satellite communication frequency band.

The present invention has been disclosed through the above-mentioned embodiments, but this is not intended to limit the present invention. Any person having ordinary skill in the art can make some changes and modifications without departing from the spirit and scope of the present invention after understanding the foregoing technical features and embodiments of the present invention. Therefore, the patent protection scope of the present invention should be subject to the claims attached to this specification.

What is claimed is:

1. An active dual-band liquid crystal transmissive and reflective array structure, comprising:
a first substrate layer, having a first upper surface and a first lower surface;
a second substrate layer, having a second upper surface and a second lower surface;
a first liquid crystal layer, stacked and connected between the first substrate layer and the second substrate layer;
a plurality of first surface units, arranged in an array on the first upper surface, wherein each first surface unit has four first surface outer frame patches and a first surface cross-shaped patch, wherein a first surface inner frame patch is disposed inside the first surface outer frame patch;
a plurality of second surface units, arranged in an array on the first lower surface, wherein each second surface unit has four second surface rectangular patches, wherein the edges of each second surface rectangular patch are connected to four second surface metal wires, and a second surface cross-shaped slot is disposed at the center of the second surface rectangular patch;
a plurality of third surface units, arranged in an array on the second upper surface, wherein each third surface unit has four third surface rectangular patches, wherein the edges of each third surface rectangular patch is connected to four third surface metal wires, and a third surface square slot is disposed at the center of the third surface rectangular patch; and
a plurality of fourth surface units, arranged in an array on the second lower surface, wherein each fourth surface unit is a fourth surface cross-shaped patch,
wherein the first surface outer frame patch, the first surface inner frame patch, the first substrate layer, the second surface rectangular patch, the four second surface metal wires connected to the edges of the second surface rectangular patch, the first liquid crystal layer, the second substrate layer, the third surface rectangular patch, the four third surface metal wires connected to the edges of the third surface rectangular patch form a reflective cell unit; when the first liquid crystal layer is not biased, the central operating frequency of the reflective cell unit is between 27 GHz and 29 GHz,
wherein the first surface cross-shaped patch, the first substrate layer, the second surface unit, the first liquid crystal layer, the third surface unit, the second substrate layer, and the fourth surface unit form a transmissive cell unit; when the first liquid crystal layer is biased, the central operating frequency of the transmissive cell unit is between 17 GHz and 19 GHz.

2. The active dual-band liquid crystal transmissive and reflective array structure as claimed in claim 1, wherein every the four first surface outer frame patches are arranged around the first surface cross-shaped patch; a first surface rectangular slit is disposed between the first surface outer frame patch and the first surface inner frame patch, and a first surface rectangular slot is disposed at the center of the first surface inner frame patch.

3. The active dual-band liquid crystal transmissive and reflective array structure as claimed in claim 1, wherein every the four second surface rectangular patches and the second surface metal wire surrounds a second surface cross-shaped opening.

4. The active dual-band liquid crystal transmissive and reflective array structure as claimed in claim 1, wherein every the four third surface rectangular patches and the third surface metal wire surrounds a third surface cross-shaped opening.

5. The active dual-band liquid crystal transmissive and reflective array structure as claimed in claim 1, wherein the first surface unit, the second surface unit, the third surface unit, andthe fourth surface unit are formed of a metal material.

6. The active dual-band liquid crystal transmissive and reflective array structure as claimed in claim 1, wherein before and after the first liquid crystal layer is biased, the dielectric constant of the first liquid crystal layer is 2.55~3.76, and the loss tangent thereof is 0.004~0.006.

7. The active dual-band liquid crystal transmissive and reflective array structure as claimed in claim 1, wherein the length and width of the first surface outer frame patch are 0.5~3.3mm.

8. The active dual-band liquid crystal transmissive and reflective array structure as claimed in claim 1, wherein the first surface cross-shaped patch has a first longitudinal portion and a first transverse portion, and the lengths of the first longitudinal portion and the first transverse portion are 1.5~8.5 mm.

9. The active dual-band liquid crystal transmissive and reflective array structure as claimed in claim 1, wherein the second surface cross-shaped slot has a second longitudinal portion and a second transverse portion, the widths of the second longitudinal portion and the
second transverse portion are 0.57~0.67 mm, and the lengths of the second longitudinal portion and the second transverse portion are 3.25~93.35 mm.

10. The active dual-band liquid crystal transmissive and reflective array structure as claimed in claim 1, wherein when the first liquid crystal layer is not biased, the reflective cell unit can be used as a reflective surface at the central operating frequency of 27~29 GHz; when the first liquid crystal layer is biased, the transmissive cell unit can be used as a transmissive surface at the central operating frequency of 17~19 GHz.
